(19) United States
(12) Patent Application Publication
(10) Pub. No.: US 2010/0224703 A1
(43) Pub. Date: Sep. 9, 2010

(54) Pneumatic Atomization Nozzle for Web Moistening

(75) Inventors: Kui-Chiu Kwok, Gurnee, IL (US); Kenneth H. Dorman, Carol Stream, IL (US)

Correspondence Address: FLETCHER YODER (ILLINOIS TOOL WORKS INC.), P.O. BOX 692289, HOUSTON, TX, 77269-2289, US

(73) Assignee: Illinois Tool Works Inc., Glenview, IL (US)

(21) Appl. No.: 12/400,146

(22) Filed: Mar. 9, 2009

(51) Int. Cl. B05B 1/14

(52) U.S. Cl. 239/548

(57) ABSTRACT

A system, in certain embodiments, includes a pneumatic web moistening nozzle. The pneumatic web moistening nozzle includes a liquid orifice, and a first pneumatic orifice and a second pneumatic orifice disposed on opposite sides of the liquid orifice. The first and second pneumatic orifices are sized longer than the liquid orifice to overlap the liquid orifice.

### BACKGROUND

The invention relates generally to a pneumatic atomization nozzle for web moistening.

Magazines, books and other publications are frequently produced on heatset web offset printing presses. Offset printing involves transferring images to a web (e.g., roll of paper) via rotating drums. These drums have an inked impression of images which are transferred to the web as it travels across the rotating drums. In heatset printing, ink may be dried by blowing hot air over the web after the images have been imprinted. However, the hot air may reduce web moisture content, resulting in a wrinkled publication.

To prevent this detrimental wrinkling, some printing presses employ a web remoistening system. For example, a web remoistening system may be used to spray the web with water after the drying process to remoisten the web. Current web remoistening systems utilize hydraulic atomization to achieve the desired web moisture content. In hydraulic atomization, a liquid is forced through a small orifice at high pressure to create droplets. Systems that employ hydraulic atomization are expensive because they must be constructed to withstand high liquid pressure. In addition, they require expensive high pressure pumps, liquid manifolds and solenoid valves. Furthermore, because the orifice is small, it tends to get clogged by impurities in the water. Therefore, hydraulic atomization systems typically spray de-ionized water, increasing operational costs. Moreover, hydraulic atomization systems are not well suited for web moistening at low flow rates because they tend to produce larger droplets, thereby causing poor moistening quality.

### BRIEF DESCRIPTION

A system, in certain embodiments, includes a pneumatic nozzle. The pneumatic nozzle includes a liquid orifice, and a first pneumatic orifice and a second pneumatic orifice disposed on opposite sides of the liquid orifice. The first and second pneumatic orifices are sized longer than the liquid orifice to overlap the liquid orifice.

### DRAWINGS

These and other features, aspects, and advantages of the present invention will become better understood when the following detailed description is read with reference to the accompanying drawings in which like characters represent like parts throughout the drawings, wherein:

FIG. 1 is a process flow diagram of a printing process in accordance with certain embodiments of the present technique;

FIG. 2 is a block diagram of a web moistening system in accordance with certain embodiments of the present technique;

FIG. 3 is a perspective view of a web moistening system in accordance with certain embodiments of the present technique;

FIG. 4 is a top view of three spray devices that may be employed in the web moistening system of FIG. 3;

FIG. 5 is a perspective view of a spray device that may be employed in the web moistening system of FIG. 3;

FIG. 6 is a front view of a spray device that may be employed in the web moistening system of FIG. 3;

FIG. 7 is an exploded view of a spray device that may be employed in the web moistening system of FIG. 3;

FIG. 8 is a top view of a first layer of the spray device represented in FIG. 7;

FIG. 9 is a top view of a second layer of the spray device represented in FIG. 7;

FIG. 10 is a top view of a third layer of the spray device represented in FIG. 7; and

FIG. 11 is a top view of a fourth layer of the spray device represented in FIG. 7.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Embodiments of the present disclosure may reduce the cost of web moistening systems and provide enhanced moistening performance by employing pneumatic web moistening nozzles. In certain embodiments, the pneumatic web moistening nozzle includes a liquid orifice and a pair of pneumatic orifices disposed on opposite sides of the liquid orifice. In this configuration, liquid droplets emitted from the liquid orifice may form a substantially flat fan-shaped pattern in a plane of the orifices. Furthermore, in certain embodiments, the pneumatic orifices may be sized longer than the liquid orifice to overlap or sandwich the liquid orifice. This configuration may confine liquid droplets to the plane of the fan-shaped stream, thereby providing substantially uniform web moistening. As discussed in detail below, pneumatic web moistening nozzles may utilize larger liquid orifices and provide higher droplet velocities than hydraulic atomizers. The larger liquid orifice may be less prone to clogging because small particles may simply pass through instead of becoming lodged and obstructing liquid flow. Because the liquid orifice may be able to accommodate particles in the liquid, tap water may be used as the moistening liquid, instead of the more expensive de-ionized water. In addition, the larger liquid orifice may facilitate spraying other liquids, including silicone and lotion. Moreover, the higher droplet velocities may increase liquid deposition efficiency, facilitating increased web speed through the web moistening system.

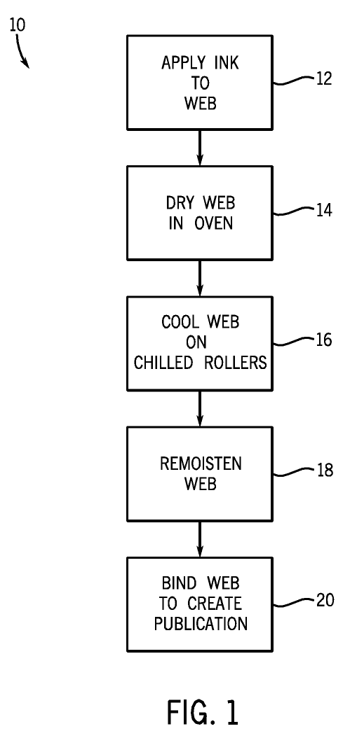

FIG. 1 presents a process flow diagram of heatset web offset printing 10 using a unique web remoistening system in accordance with certain embodiments of the invention. First, as represented by block 12, ink is applied to a web. The web may be paper, for example, or any other substrate to which ink may be applied. The web is stored in rolls, which are unwound as the web travels through the printing process 10. In offset printing, ink is first applied to a rotating plate cylinder by ink rollers. The ink is then transferred to an offset cylinder which is in contact with the plate cylinder and rotating in the opposite direction. Finally, ink is applied to the web as it travels across the rotating offset cylinder.

However, the ink is still wet at this point in the printing process 10. Therefore, the process 10 may proceed to dry the ink in an oven, as represented by block 14. Web drying ovens generally circulate hot air over the web to dry the ink before it runs or smudges. Because the drying process 14 may leave the web excessively hot, the web may be cooled on a series of chilled rollers, as represented by block 16.

Heating the web in the oven, as represented by block 14, may have the undesirable effect of reducing web moisture content. If the web becomes too dry, it may wrinkle during the binding process. Therefore, the printing process 10 may employ a liquid spray system to remoisten the web, as represented by block 18. For example, the web remoistening system may employ a series of nozzles which spray a liquid onto the web as it travels through the system. In the disclosed embodiments, the web remoistening system may include pneumatic web moistening nozzles that provide high droplet deposition efficiency and substantially uniform spray patterns. This configuration may provide increased web speed through the web remoistening system. Once the proper moisture content has been established, the web may be bound into its final publication form, as represented by block 20. For example, the web may be bound into books, or stapled to create magazines.

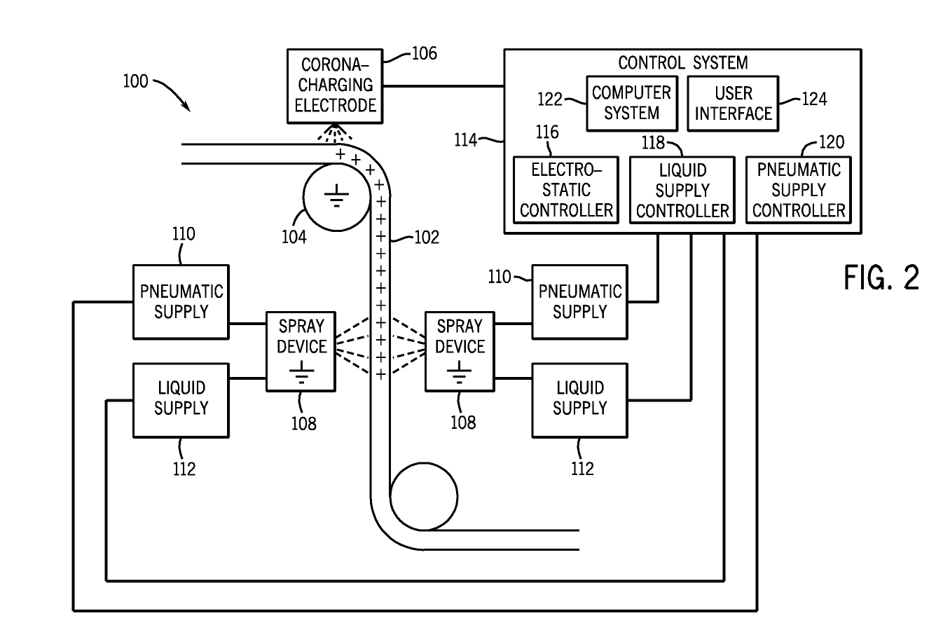

FIG. 2 shows a block diagram of one embodiment of a web moistening system 100 using a unique configuration to enhance droplet deposition efficiency and provide uniform droplet distribution in accordance with certain embodiments of the invention. As previously discussed, a web 102 may enter the moistening system 100 after it has been cooled by the chilled rollers. The web 102 may then pass over a reversing roller 104 and be charged by a corona-charging electrode 106. The corona-charging electrode 106 bombards the web 102 with ions (charged particles), inducing a positive charge in the web 102. This positive charge is represented by plus signs located on the side of the web 102. To ensure that the maximum possible charge is applied, the reversing roller 104 may be grounded.

The web may then pass between a pair of spray devices 108. While only two spray devices 108 are depicted in FIG. 2, each spray device 108 may represent a series of spray devices 108 extending along the width of the web 102 (e.g., perpendicular to the page). Also, additional spray devices 108 may be positioned along the direction of travel of the web 102. The number and configuration of spray devices 108 may be selected to achieve proper web moisture content. Each spray device 108 may be grounded. During atomization, the positively charged web 102 may induce a negative charge on the liquid droplets. As the droplets approach the web 102, they may then be electrostatically attracted to the web 102, resulting in increased liquid penetration.

The spray devices 108 in the present embodiment may be pneumatic atomizers. As discussed in detail below, pneumatic atomizers may utilize large liquid orifices and provide high droplet velocities. The large liquid orifice may be less prone to clogging because small particles may simply pass through instead of becoming lodged and obstructing liquid flow. Moreover, the high droplet velocities may increase liquid deposition efficiency, facilitating increased web speed through the web moistening system 100. Such spray devices 108 may use both a gas source and a liquid source. Gas may be supplied by pneumatic supplies 110, such as low pressure, high volume blowers, for example. Liquid may be supplied by liquid supplies 112. In this embodiment, a low liquid flow rate may be desired. Therefore, the liquid supplies 112 may be gear pumps or peristaltic pumps. For example, gear pumps may be configured to provide a constant flow of liquid to the spray devices 108. In addition, flow rate may be easily adjusted by varying gear speed, gear size and number of teeth on each gear.

The corona-charging electrode 106, the pneumatic supplies 110 and the liquid supplies 112 may be controlled by a control system 114. The control system 114 may include an electrostatic controller 116, a liquid supply controller 118, a pneumatic supply controller 120, a computer system 122 and a user interface 124. For example, the electrostatic controller 116 may adjust the voltage and/or current supplied to the corona-charging electrode 106 based on a desired web charge. Similarly, the liquid supply controller 118 and the pneumatic supply controller 120 may adjust the output of the liquid supply 112 and the pneumatic supply 110. For example, if the liquid supplies 112 are gear pumps, the liquid supply controller 118 may adjust the speed of each gear pump based on a desired liquid flow rate. Each of the individual controllers may be regulated by the computer system 122 coupled to the user interface 124. The user interface 124 may allow an operator to adjust parameters of the web moistening system 100 through a graphical user interface.

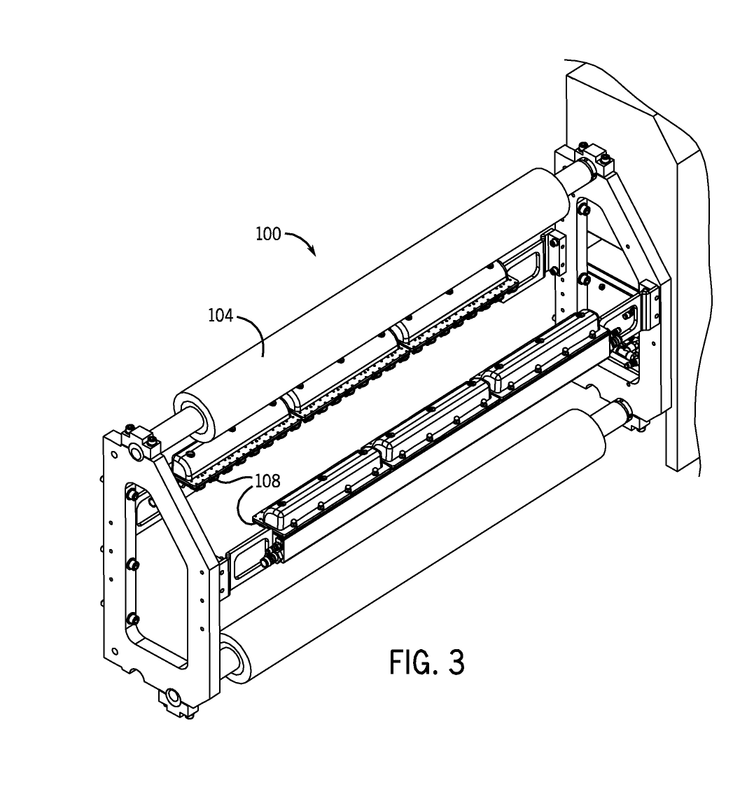

FIG. 3 is a perspective view of a web moistening system 100 having a unique atomization mechanism in accordance with certain embodiments of the invention. In this embodiment, the web (not shown) may enter along the reversing roller 104. The web may then pass between two rows of spray devices 108, one on each side of the web. Each spray device 108 may spray a fan shaped stream of liquid onto the web, establishing the desired moisture content. Because the present embodiment utilizes pneumatic atomizers, the liquid stream may have a greater velocity than web moistening systems 100 employing hydraulic atomizers. This higher velocity stream may increase liquid deposition efficiency, facilitating a higher web speed through the web moistening system 100. For example, web speeds of approximately 1,000 to 3,000 feet per minute may be possible using the pneumatic atomizers of the present embodiment.

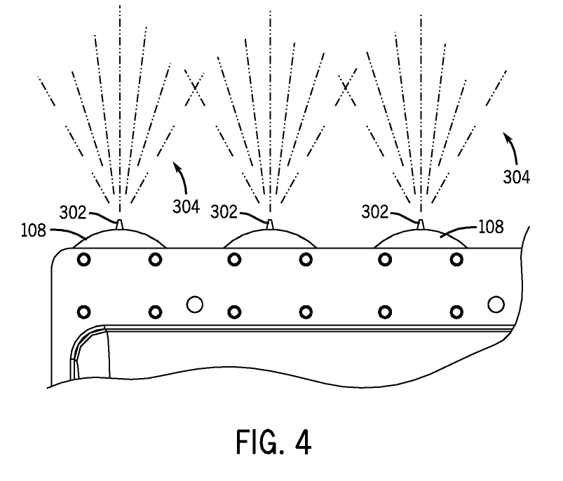

FIG. 4 is a top view of three spray devices 108 that may be employed in the present embodiment. As illustrated, each spray device 108 may project a fan-shaped droplet pattern 304 from a liquid orifice 302. The fan-shaped droplet pattern 304 may be substantially flat and oriented in a direction perpendicular to the direction of travel of the web. The liquid streams 304 depicted in FIG. 4 overlap each other as they expand. In other embodiments, the spacing of the spray devices 108 and/or the angle of each fan-shaped droplet pattern 304 may be varied to alter the amount of overlap. Adjustment of these parameters may be based on a desired level of web moistening.

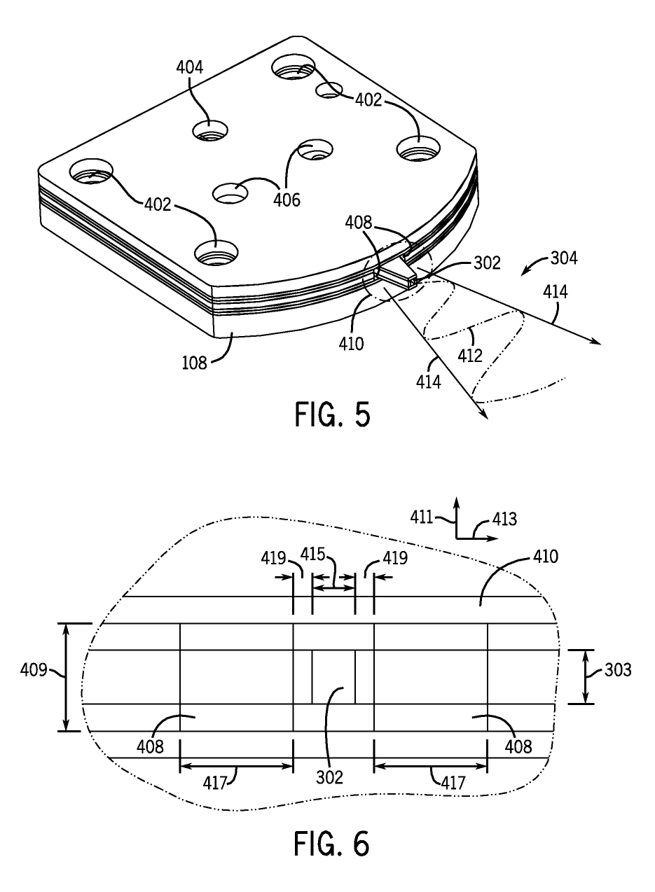

FIG. 5 is a perspective view of a spray device 108 having a unique atomization mechanism in accordance with certain embodiments of the invention. As discussed in detail below, the spray device 108 may be composed of layers, with each layer bolted together to form a complete apparatus. To facilitate bolting the layers together, bolt holes 402 may pass through the entire spray device 108. Bolts may pass through these holes to secure the layers.

A liquid inlet 404 may serve to deliver liquid from the liquid supply 112 to the liquid orifice 302. Similarly, pneumatic inlets 406 may facilitate gas flow from the pneumatic supply 110 through the spray device 108 to pneumatic orifices 408. Both the liquid orifice 302 and the pneumatic orifices 408 are components of the nozzle 410.

Liquid exiting the liquid orifice 302 may be separated into droplets by pneumatic atomization. The liquid orifice 302 may emit liquid at a relatively low flow rate, while the pneumatic orifices 408 may expel gas at a relatively high flow rate. Interaction between the high flow rate gas and the low flow rate liquid may cause the liquid to break up into droplets. Furthermore, some of the energy from the gas may be transferred to the liquid, increasing liquid droplet velocity. Because droplet velocity is a function of gas flow rate, pneumatic atomization may produce high velocity droplets while maintaining a low liquid flow rate. This configuration, unattainable with hydraulic atomization, may be well-suited for web moistening where greater droplet velocity and lower liquid flow rates are desired.

As seen in FIG. 5, the liquid droplets emitted from liquid orifice 302 form a substantially flat fan-shaped pattern 304. This pattern 304 may include vacillating droplets established by gas streams emanating between the pneumatic orifices 408. Specifically, two gas streams emanating from the pneumatic orifices 408 may converge near the liquid orifice 302. These high velocity gas stream may induce a liquid stream emitted from liquid orifice 302 to form vacillating droplets. FIG. 5 shows an exemplary droplet 412 as it vacillates in space between boundaries 414. This droplet 412 is merely representative of droplets formed through the pneumatic atomization process. The frequency and amplitude of this vacillation may be controlled by varying the liquid and/or gas flow rates, the liquid and/or gas velocities, and/or the spacing between the liquid orifice 302 and the pneumatic orifices 408. Adjusting the parameters of droplet vacillation is described in more detail in U.S. Pat. No. 5,902,540, which is herein incorporated by reference in its entirety.

Droplet vacillation may not be visible in the fan-shaped streams 304 depicted in FIG. 4 because each droplet may vacillate at a high frequency. A combination of this high frequency vacillation and a large number of droplets may create the appearance of the relatively flat fan-shaped droplet pattern 304. The particular fan-shaped pattern 304 created by this vacillation may result in uniform web moistening.

The flow rates of both liquid and gas are particularly adjusted to maintain the fan-shaped droplet pattern 304. Specifically, if the gas flow rate is too high relative to the liquid flow rate, liquid droplets may not properly vacillate to form the fan spray pattern 304. Without proper vacillation, the flattened fan-shaped pattern 304 may rotate approximately 90°, resulting in ineffective web moistening. For example, in certain embodiments, the liquid flow rate may be about 2 to 100, 5 to 70, 10 to 50, or approximately 10 to 30 cubic centimeters per minute. For example, if the liquid flow rate is approximately 10 to 30 cubic centimeters per minute, a gas flow rate of about 1 to 20, 2 to 10, or approximately 2 to 5 standard cubic feet per hour may produce proper droplet vacillation.

The liquid orifice 302 depicted in FIG. 5 protrudes from the front face of the spray device 108 such that the liquid orifice 302 is positioned downstream from the gas flow of pneumatic orifices 408. As illustrated, the protrusion is both rectangular and tapered. Alternative embodiments may employ a liquid orifice 302 having a non-tapered protrusion and/or a non-rectangular configuration. For example, in certain embodiments, the protrusion may have a circular, elliptical or triangular cross-section. This protrusion may facilitate automatic unclogging of the liquid orifice 302. A portion of the gas emitted from each pneumatic orifice 408 may pass over the liquid orifice 302. In this configuration, if an object or liquid on the surface obstructs the flow of liquid, the gas flow may dislodge it.

FIG. 6 is a front view of the nozzle 410 component of the spray device 108. The nozzle 410 depicted in this figure contains a rectangular liquid orifice 302 and rectangular pneumatic orifices 408. Experimentation has determined that rectangular orifices may produce effective spray patterns for web moistening. Furthermore, FIG. 6 shows that the pneumatic orifices 408 are longer than the liquid orifice 302. In particular, pneumatic orifices 408 have a length 409, whereas liquid orifice 302 has a length 303. In certain embodiments, length 409 may be at least 1.1, 1.2, 1.3, 1.4, 1.5, 1.6, 1.7, 1.8, 1.9, 2, 3, 4, 5, or more times length 303. For example, length 409 may be more than approximately 20 percent longer than length 303. Furthermore, liquid orifice 302 may be positioned such that pneumatic orifices 408 extend past opposite ends of liquid orifice 302 along a vertical axis 411. This overlapping, or sandwich, configuration may reduce tails by confining liquid droplets to the plane of the fan-shaped stream. Tails are undesirable components of a spray pattern that are formed when a small number of droplets travel outside of the desired flow pattern. Confining these droplets to the fan-shaped stream may provide a more uniform liquid distribution across the web 102. Alternative embodiments may employ pneumatic orifices 408 that extend past only one end of liquid orifice 302 along the vertical axis 411.

Dimensions of both the liquid orifice 302 and the pneumatic orifices 408 may be varied based on the desired liquid spray configuration. For example, if a greater gas velocity is desired, the size of the pneumatic orifices 408 may be reduced. In addition, larger droplets may be formed by increasing the size of the liquid orifice 302. However, as previously discussed, the disclosed embodiments may maintain the rectangular shape of orifices 302 and 408, where the pneumatic orifices 408 are longer than the liquid orifice 302. Therefore, a width 415 of liquid orifice 302 and a width 417 of pneumatic orifices 408 may be varied to adjust the size of orifices 302 and 408, respectively. In the present embodiment, the width 415 of liquid orifice 302 is substantially similar to the width 417 of pneumatic orifices 408. However, widths 415 and 417 may vary in alternative embodiments. In addition, the length 303 of liquid orifice 302 may be approximately two times the width 415, as illustrated in FIG. 6. Alternatively, the length 303 may be about 1, 1.2, 1.4, 1.6, 1.8, 2, 2.2, 2.4, 2.6, 2.8 or more times the width 415 of liquid orifice 302, for example. Similarly, as illustrated in FIG. 6, the length 409 of pneumatic orifices 408 may be four times the width 417. In alternative embodiments, the length 409 may be about 1, 1.5, 2, 2.5, 3, 3.5, 4, 4.5, 5, 5.5, 6, 6.5 or more times the width 417 of pneumatic orifices 408, for example.

Furthermore, orifice spacing may be varied to alter the frequency and/or amplitude of droplet vacillation, for example. As illustrated, pneumatic orifices 408 are spaced a distance 419 from liquid orifice 302 along lateral axis 413. As presented in FIG. 6, spacing 419 is approximately 1.5 times the width 415 of liquid orifice 302. In alternative embodiments, the spacing 419 may be about 0.5, 1, 1.5, 2, 2.5 or more times the width 415 of liquid orifice 302. Further embodiments may enhance droplet formation by minimizing the spacing 419, such that spacing 419 approaches zero. By adjusting dimensions of nozzle components, spray patterns may be configured for particular applications.

One advantage of the present embodiment is that the liquid orifice 302 may be larger than the liquid orifice of a hydraulic atomizer. Hydraulic atomizers generally require a small liquid orifice to sufficiently accelerate the liquid linearly and/or rotationally such that it atomizes. In contrast, pneumatic atomizers use gas flow to atomize liquid. Therefore, a larger liquid orifice 302 may be employed. Larger liquid orifices may be less prone to clogging because small particles may simply pass through instead of becoming lodged and obstructing liquid flow. Because the liquid orifice 302 may be able to accommodate particles in the liquid, tap water may be used as the moistening liquid, instead of the more expensive de-ionized water typically utilized in hydraulic atomizers. In addition, the larger liquid orifice 302 may facilitate spraying other liquids, including silicone and lotion, that may be too viscous to flow through the smaller orifice of a hydraulic atomizer.

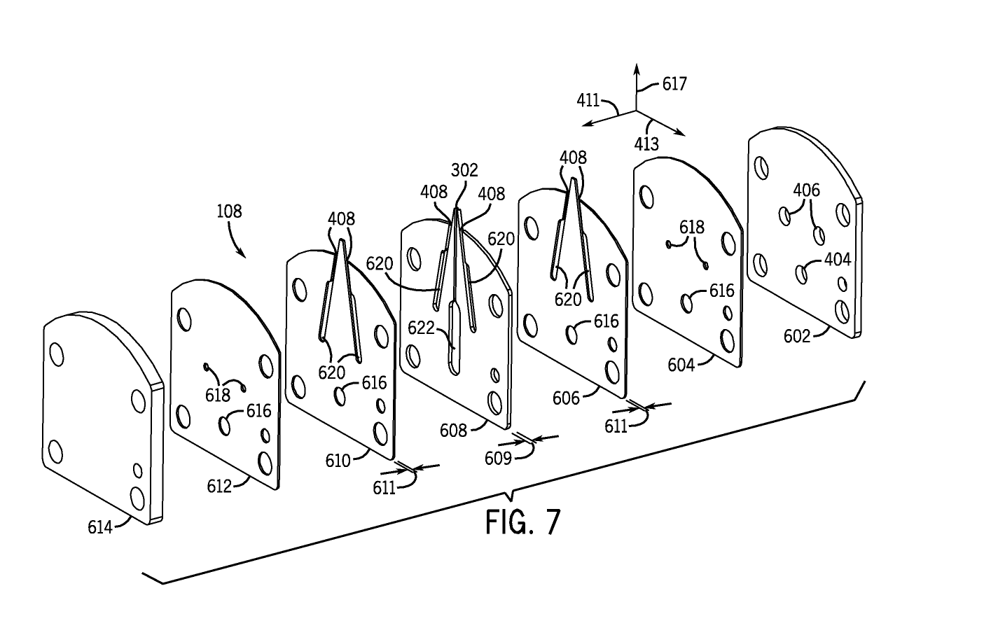

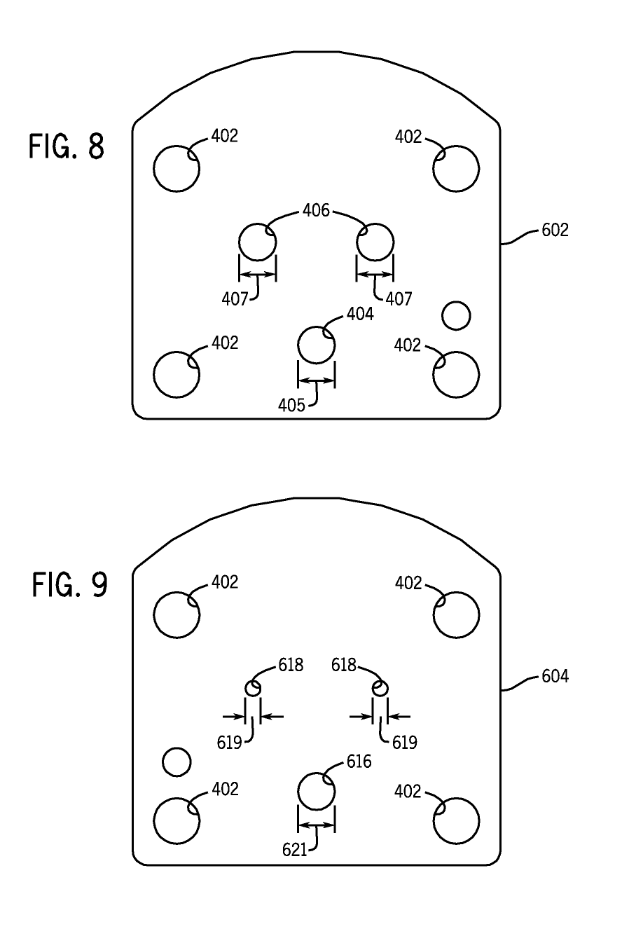

FIGS. 7-11 show layers 602, 604, 606, 608, 610, 612 and 614 of an exemplary embodiment of the spray device 108. As previously discussed, the spray device 108 may be formed from multiple layers of material. All of the layers, 602 through 614, for one embodiment are depicted in FIG. 7, while FIGS. 8-11 show a top view of the individual layers. As discussed in detail below, gas and liquid enter the spray device 108 along the vertical axis 411 generally perpendicular to layers 602 through 614. The spray device 108 then expels the gas and liquid in a plane defined by a horizontal axis 617 and lateral axis 413, generally in the plane of layers 602 through 614.

Layer 602 is the top layer of the spray device 108. A top view of this layer may be seen in FIG. 8. As illustrated, liquid from the liquid supply 112 may enter the liquid inlet 404 along vertical axis 411. Similarly, gas from the pneumatic supply 110 may enter pneumatic inlets 406 along vertical axis 411. As previously discussed, layer 602 includes bolt holes 402 configured to facilitate securing layers 602 through 614 together with bolts.

A top view of the second layer 604 may be seen in FIG. 9. This layer contains a vertical liquid conduit 616 which may facilitate liquid flow from the liquid inlet 404 to the liquid orifice 302. Similarly, two vertical pneumatic conduits 618 are located in layer 604. These conduits enable gas to travel through the spray device to the pneumatic orifices 408. The vertical pneumatic conduits 618 are configured to control gas flow under a given pressure drop. Specifically, smaller conduit size reduces gas consumption under the same pressure drop. As can best be seen in FIGS. 8 and 9, a diameter 619 of the vertical pneumatic conduits 618 is smaller than a diameter 407 of the pneumatic inlets 406. For example, the diameter 407 may be more than approximately 1.5, 2, 2.5, 3, 3.5, 4, or more times the diameter 619. Furthermore, a diameter 405 of the liquid inlet 404 may be substantially similar to or larger than a diameter 621 of the vertical liquid conduit 616. However, the diameter and shape of the vertical conduits 616 and 618 within this layer may be varied in alternative embodiments based on desired flow properties.

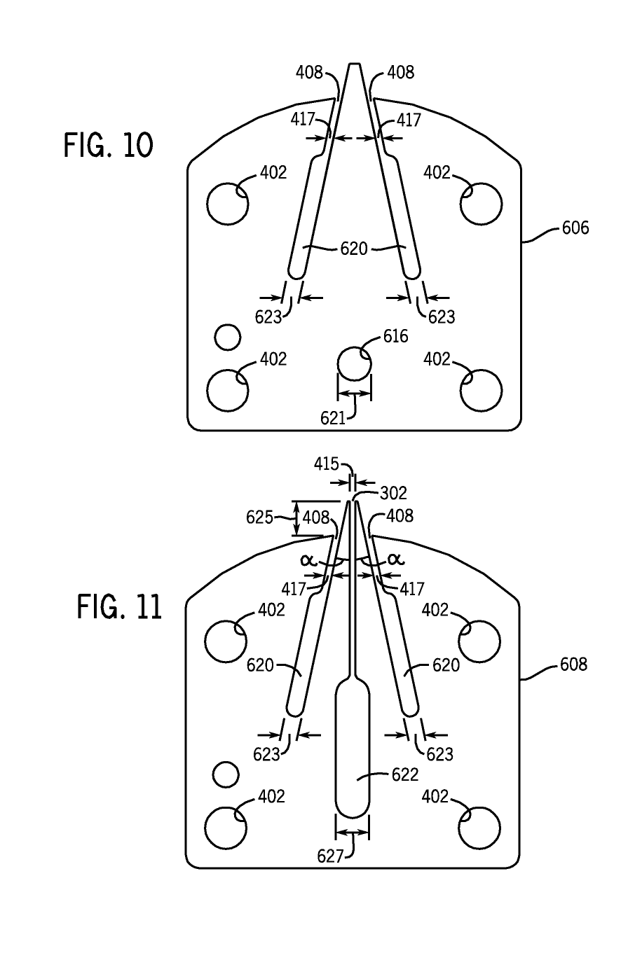

FIG. 10 depicts a top view of the third layer 606. This layer includes another section of the vertical liquid conduit 616. Layer 606 also contains two horizontal pneumatic conduits 620 which redirect gas from the vertical pneumatic conduits 618 to the pneumatic orifices 408. As can be seen in FIG. 7, an initial width 623 of the horizontal pneumatic conduits 620 is substantially similar to the diameter 619 of the vertical pneumatic conduits 618. However, the horizontal pneumatic conduits 620 narrow as they approach the pneumatic orifices 408. Specifically, width decreases from the initial width 623 to a width 417 at the pneumatic orifices 408. For example, the width 623 may be more than about 1.2, 1.4, 1.6, 1.8, 2, 2.2, 2.4, 2.6, 2.8 or more times the width 417.

A top view of the fourth layer 608 is shown in FIG. 11. This layer contains the two horizontal pneumatic conduits 620, as seen in layer 606 (FIG. 10). In addition, layer 608 contains a horizontal liquid conduit 622 that transfers liquid from the vertical liquid conduit 616 to the liquid orifice 302. As best seen in FIG. 7, an initial width 627 of the horizontal liquid conduit 622 is substantially the same as the diameter 621 of the vertical liquid conduit 616. Furthermore, the width of the horizontal liquid conduit 622 progressively decreases to correspond to a width 415 of the liquid orifice 302. As with the horizontal pneumatic conduits 620, the configuration of the horizontal liquid conduit 622 affects liquid flow properties.

FIG. 11 also depicts an angle, α, between each horizontal pneumatic conduit 620 and the horizontal liquid conduit 622. This angle may be adjusted between approximately 0° and 90°. For example, in certain embodiments, a is about 10°, 20°, 30°, 40°, 50°, 60°, 70° or 80°, or an angle therebetween. As depicted in FIG. 11, a is approximately 10°. Experimentation has determined that an angle α of approximately 30° may be well-suited for certain web moistening applications. Varying a may affect both the configuration of the fan-shaped stream and the ability of the gas streams to dislodge obstructions in the liquid orifice 302.

As previously discussed, liquid orifice 302 may protrude in a downstream direction from the gas flow of the pneumatic orifices 408. As illustrated, liquid orifice 302 is positioned a distance 625 from the face of spray device 108. In certain embodiments, distance 625 may be approximately 0, 1, 2, 3, 4, 5, 6, 7, 8, 9, 10 or more times the width 415 of liquid orifice 302. As described above, the protrusion of liquid orifice 302 is tapered at an angle α and has a generally rectangular shape. Positioning the liquid orifice 302 downstream from the pneumatic orifices 408 may serve to dislodge obstructions in the liquid orifice 302. However, in alternative embodiments, liquid orifice 302 may be positioned substantially flush with the face of spray device 108.

Layer 610, as depicted in FIG. 7, is substantially similar to layer 606, and layer 612 is substantially similar to layer 604. As can be seen in FIG. 7, the top and bottom of the horizontal liquid conduit 622 is formed by layers 606 and 610, respectively. In other words, liquid flowing through the horizontal liquid conduit 622 is confined to a path through layer 608. Therefore, the length 303 of the horizontal liquid conduit 622, and liquid orifice 302, along vertical axis 411 is equal to a thickness 609 of layer 608.

In addition, layers 604 and 612 serve to confine the flow of gas to the horizontal pneumatic conduits 620. Unlike the horizontal liquid conduit 622, the length 409 of horizontal pneumatic conduits 620, and pneumatic orifices 408, along vertical axis 411 is equal to the thickness 609 of layer 608 combined with thicknesses 611 of layers 606 and 610. As a result of this layering, the length 409 of the pneumatic orifices 408 is greater than the length 303 of the liquid orifice 302. Layer 612 serves to provide symmetry to the spray device 108 between layers 604 and 612. In this configuration, layers 604 to 612, as a stack, may be rotated 180 degrees about horizontal axis 617 and sandwiched between layers 602 and 614. Alternative embodiments may omit layer 612 such that layer 614 serves to confine the flow of gas to the horizontal pneumatic conduits 620.

The final layer of the spray device 108 is layer 614. This layer serves as an end cap for both the vertical pneumatic conduits 618 and the vertical liquid conduit 616. By capping these conduits, both gas and liquid are forced to exit their respective orifices. As appreciated, in addition to the multi-layered assembly described above, other embodiments of the spray device 108 may be constructed using alternative techniques. For example, the spray device 108 may be machined from solid blocks of material.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a pneumatic nozzle, comprising:
a liquid orifice;
a first pneumatic orifice and a second pneumatic orifice disposed on opposite sides of the liquid orifice, wherein the first and second pneumatic orifices are sized longer than the liquid orifice to overlap the liquid orifice.

2. The system of claim 1, wherein the liquid orifice and the first and second pneumatic orifices are rectangular.

3. The system of claim 1, wherein the liquid orifice comprises a protrusion that extends downstream from the first and second pneumatic orifices.

4. The system of claim 3, wherein the protrusion is rectangular and tapered.

5. The system of claim 1, wherein the first and second pneumatic orifices are at least 20 percent longer than the liquid orifice, and the first and second pneumatic orifices overlap opposite ends of the liquid orifice.

6. The system of claim 1, comprising a plurality of layers defining passages leading to the liquid orifice and the first and second pneumatic orifices, wherein thicknesses of the layers define lengths of the first and second pneumatic orifices longer than the liquid orifice.

7. The system of claim 1, comprising a plurality of spray devices arranged in a row, wherein each spray device comprises the pneumatic nozzle.

8. The system of claim 1, wherein the pneumatic nozzle is configured to pneumatically atomize a liquid into a plane defined by the liquid orifice and the first and second pneumatic orifices.

9. The system of claim 1, comprising a plurality of rollers configured to feed a web along the pneumatic nozzle, wherein the rollers comprise a chilled roller and a grounded reversing roller, the system comprises a corona-charging electrode configured to impart a positive charge on the web, the pneumatic nozzle is grounded such that fluid sprayed onto the web becomes negatively charged and is attracted to the positively charged web.

10. A system, comprising:
a layered nozzle, comprising:
a first set of layers comprising a liquid path leading to a liquid orifice, wherein the first set of layers defines a first length of the liquid orifice; and
a second set of layers comprising a pneumatic path leading to a first pneumatic orifice, wherein the second set of layers defines a second length of the first pneumatic orifice, the second length is greater than the first length, and the liquid orifice and the first pneumatic orifice are rectangular.

11. The system of claim 10, wherein the first and second sets of layers include at least one common layer at least partially defining both the liquid orifice and the first pneumatic orifice, and the first pneumatic orifice is at least partially defined by at least one different layer not defining the liquid orifice.

12. The system of claim 10, wherein the second set of layers comprises another pneumatic path leading to a second pneumatic orifice, wherein the first and second pneumatic orifices are disposed on opposite sides of the liquid orifice.

13. The system of claim 12, comprising a plurality of layers including the first and second sets of layers, wherein the plurality of layers comprises:
a first layer having a plurality of pneumatic inlets and a liquid inlet;
a second layer having a plurality of vertical pneumatic conduits in fluid communication with the plurality of pneumatic inlets, and a vertical liquid conduit in fluid communication with the liquid inlet;
a third layer having a plurality of horizontal pneumatic conduits, the first and second pneumatic orifices, and the vertical liquid conduit;
a fourth layer having the plurality of horizontal pneumatic conduits, the first and second pneumatic orifices, a horizontal liquid conduit in fluid communication with the vertical liquid conduit, and liquid orifice;
a fifth layer having the plurality of horizontal pneumatic conduits, the first and second pneumatic orifices, and the vertical liquid conduit;
a sixth layer having the plurality of vertical pneumatic conduits and the vertical liquid conduit; and
a seventh layer configured to cap ends of the plurality of vertical pneumatic conduits and the vertical liquid conduit.

14. The system of claim 10, comprising a plurality of spray devices arranged in a row, wherein each spray device comprises the layered nozzle, further comprising a plurality of rollers configured to feed a web along the layered nozzle, wherein the rollers comprise a chilled roller and a grounded reversing roller, the system comprises a corona-charging electrode configured to impart a positive charge on the web, the layered nozzle is grounded such that liquid sprayed onto the web becomes negatively charged and is attracted to the positively charged web.

15. The system of claim 10, wherein the liquid orifice comprises a protrusion that extends downstream from the first pneumatic orifice, and the protrusion is rectangular and tapered.

16. A method, comprising:
directing pneumatic flows in an overlapping relationship about opposite sides of a liquid flow at an exit of a nozzle;
vacillating the liquid flow in a plane predominantly parallel to the pneumatic flows; and
limiting tails of the liquid flow by substantially confining the liquid flow to the plane via the overlapping relationship of the pneumatic flows about the liquid flow.

17. The method of claim 16, wherein a pneumatic flow rate of the pneumatic flows is greater than a liquid flow rate of the liquid flow.

18. The method of claim 16, comprising automatically removing obstructions from a liquid orifice by directing at least a portion of the pneumatic flows over the liquid orifice.

19. The method of claim 16, comprising depositing the liquid flow on a web moving in a direction perpendicular to the plane.

20. The method of claim 16, wherein directing comprises discharging the pneumatic flows into the atmosphere from a pair of rectangular pneumatic orifices disposed about a rectangular liquid orifice, and the rectangular pneumatic orifices are sized longer than the rectangular liquid orifice to provide the overlapping relationship.
